(19) United States
(12) Patent Application Publication
(10) Pub. No.: US 2016/0065843 A1
(43) Pub. Date: Mar. 3, 2016

(54) METHOD AND APPARATUS FOR CREATING PHOTO-TAKING TEMPLATE DATABASE AND FOR PROVIDING PHOTO-TAKING RECOMMENDATION INFORMATION

(71) Applicant: ALIBABA GROUP HOLDING LIMITED, George Town (KY)

(72) Inventor: Lielan ZHU, Hangzhou (CN)

(73) Assignee: ALIBABA GROUP HOLDING LIMITED

(21) Appl. No.: 14/821,420

(22) Filed: Aug. 7, 2015

(30) Foreign Application Priority Data
Sep. 2, 2014 (CN) 201410443982.1

(51) Int. Cl. H04N 5/232; G06F 17/30; G06T 7/00

(52) U.S. Cl. CPC H04N 5/23222; G06T 7/004; G06T 7/0083; G06F 17/30256; G06T 2207/10004; G06T 2207/30196

(57) ABSTRACT

Apparatus and method are disclosed for creating a photo-taking template database. The method may include acquiring an image and determining whether the image meets at least one qualification factor. The method may also include storing the image as a photo-taking template and determining descriptive information. The method may also include storing the descriptive information and associating the photo-taking template with the descriptive information. In addition, apparatus and method are disclosed for providing photo-taking recommendation information. The method may include acquiring descriptive information of an object and sending a request for photo-taking recommendation to a server. The request may include the descriptive information. The method may also include receiving a photo-taking template from the server and providing photo-taking recommendation information based on the received photo-taking template.

### CROSS REFERENCE TO RELATED APPLICATION

The present application claims the benefit of priority to Chinese Application No. 201410443982.1, filed Sep. 2, 2014, the entire content of which is incorporated herein by reference.

### TECHNICAL FIELD

The present application relates to the field of network data processing technologies, and in particular relates to method and apparatus for creating a photo-taking template database and for providing photo-taking recommendation information.

### BACKGROUND

On an e-commerce platform, users often upload product photos to the platform. For example, buyers may upload photos of the products that they have purchased. In another example, sellers may upload photos of the products for sale. For some products, their features or effects may not be sufficiently demonstrated by photos of the products alone. Rather, the features or effects may be better demonstrated when such products are displayed in certain ways. For example, photos of apparels, shoes, and hats in which these products are placed on a flat surface may not be optimal in revealing their particular features. On the other hand, their features may be better demonstrated when worn by a model, either amateur (e.g., usually the seller or buyer of the products) or professional. Naturally, people wish to take good photos while wearing such products, which would benefit the sale of the products. The quality of such a photo depends largely on the posture of the person wearing the products, the shooting angle, etc.

In practice, however, most amateur users, such as average buyers wishing to provide feedback after purchasing a product, likely lack the necessary skills to take good photos, nor do they appreciate the proper posture, shooting angle, etc. to enhance the photo quality. For sellers, while some big shop sellers may afford the cost for hiring professional models or professional photographers to take high quality photos, most middle to small shops or individual sellers may not be able to afford the cost. Therefore, they may face the same problems as the majority of buyers.

The present application discloses solutions for guiding average users to take high quality photos.

### SUMMARY

In one aspect, the present disclosure is directed to a method for creating a photo-taking template database. The method may include acquiring an image based on a preset initial condition. The method may also include determining whether the image meets at least one qualification factor. In addition, the method may include storing the image as a photo-taking template in the photo-taking template database when it is determined that the image meets at least one qualification factor. The method may further include determining descriptive information based on information obtained from the image. The method may further include storing the descriptive information in the photo-taking template database and associating the photo-taking template with the descriptive information.

In another aspect, the present disclosure is directed to a method for providing photo-taking recommendation information. The method may include providing a photo-taking template database storing a plurality of photo-taking templates. Each photo-taking template may be associated with descriptive information of one or more figures included in the photo-taking template. The method may also include receiving a request for photo-taking recommendation from a client device. The request may include descriptive information of an object to be captured by a photo-taking device. The method may further include performing matching operation between the descriptive information of the object to be captured and the descriptive information associated with each photo-taking template in the photo-taking template database. In addition, the method may include determining whether a target photo-taking template is found in the photo-taking template database. The descriptive information associated with the target photo-taking template may at least partially match the descriptive information of the object to be captured. If a target photo-taking template is found, the method may include sending the target photo-taking template to the client device.

In a further aspect, the present disclosure is directed to a method for providing photo-taking recommendation information. The method may include acquiring descriptive information of an object to be captured by a photo-taking device. The method may also include sending a request for photo-taking recommendation to a server storing a plurality of photo-taking templates. The request may include the descriptive information. The method may further include receiving a photo-taking template from the server. The photo-taking template may be associated with descriptive information of one or more figures included in the photo-taking template. The descriptive information associated with the photo-taking template may at least partially match the descriptive information of the object to be captured. In addition, the method may include providing photo-taking recommendation information based on the received photo-taking template.

In a further aspect, the present disclosure is directed to an apparatus for creating a photo-taking template database. The apparatus may include a memory device for storing the photo-taking template database and a processor device communicatively coupled to the memory device. The processor device may be configured to acquire an image based on a preset initial condition. The processor device may also be configured to determine whether the image meets at least one qualification factor. In addition, the processor device may be configured to store the image as a photo-taking template in the photo-taking template database when it is determined that the image meets at least one qualification factor. The processor device may be further configured to determine descriptive information based on information obtained from the image. The processor device may be further configured to store the descriptive information in the photo-taking template database and associate the photo-taking template with the descriptive information.

In a further aspect, the present disclosure is directed to an apparatus providing photo-taking recommendation information. The apparatus may include a memory device storing a photo-taking template database. The photo-taking template may store a plurality of photo-taking templates. Each photo-taking template may be associated with descriptive information of one or more figures included in the photo-taking template. The apparatus may also include a processor device communicatively coupled to the memory device. The processor device may be configured to receive a request for photo-taking recommendation from a client device. The request may include descriptive information of an object to be captured by a photo-taking device. The processor device may also be configured to perform matching operation between the descriptive information of the object to be captured and the descriptive information associated with each photo-taking template in the photo-taking template database. The processor device may further be configured to determine whether a target photo-taking template is found in the photo-taking template database. The descriptive information associated with the target photo-taking template may at least partially match the descriptive information of the object to be captured. The processor device may be configured to send the target photo-taking template to the client device if a target photo-taking template is found.

In a further aspect, the present disclosure is directed to an apparatus providing photo-taking recommendation information. The apparatus may include a memory device and a processor device communicatively coupled to the memory device. The processor device may be configured to acquire descriptive information of an object to be captured by a photo-taking device. The processor device may also be configured to send a request for photo-taking recommendation to a server storing a plurality of photo-taking templates. The request may include the descriptive information. The processor device may further be configured to receive a photo-taking template from the server. The photo-taking template may be associated with descriptive information of one or more figures included in the photo-taking template. The descriptive information associated with the photo-taking template may at least partially match the descriptive information of the object to be captured. The processor device may be further configured to provide photo-taking recommendation information based on the received photo-taking template.

In a further aspect, the present disclosure is directed to an apparatus. The apparatus may include a photo-taking device, a memory device, and a processor device communicatively coupled to the photo-taking device and the memory device. The processor device may be configured to receive a request for taking a photo of an object and acquire descriptive information of the object. The processor device may also be configured to send a request for photo-taking recommendation to a server storing a plurality of photo-taking templates. The request may include the descriptive information. The processor device may further be configured to receive a photo-taking template from the server. The photo-taking template may be associated with descriptive information of one or more figures included in the photo-taking template. The descriptive information associated with the photo-taking template may at least partially match the descriptive information of the object to be captured. In addition, the processor device may be configured to provide photo-taking recommendation information based on the received photo-taking template and control the photo-taking device to shoot a photo of the object based on the photo-taking recommendation information.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is a flow chart of an exemplary photo-taking template database creating method, according to some embodiments of the present application.

FIG. 2 shows an exemplary photo-taking template, according to some embodiments of the present application.

FIG. 3 shows an exemplary profile curve, according to some embodiments of the present application.

FIG. 4 shows another exemplary profile curve, according to some embodiments of the present application.

FIG. 5 is a flow chart of an exemplary method for providing photo-taking recommendation information, according to some embodiments of the present application.

FIG. 6 is a flow chart of another exemplary method for providing photo-taking recommendation information, according to some embodiments of the present application.

FIG. 7 is a flow chart of another exemplary method for providing photo-taking recommendation information, according to some embodiments of the present application.

FIG. 8 is a functional schematic diagram of an exemplary apparatus, according to some embodiments of the present application.

FIG. 9 is a functional schematic diagram of another exemplary apparatus, according to some embodiments of the present application.

FIG. 10 a functional schematic diagram of another exemplary apparatus, according to some embodiments of the present application.

FIG. 11 a functional schematic diagram of another exemplary apparatus, according to some embodiments of the present application.

### DETAILED DESCRIPTION

Reference will now be made in detail to exemplary embodiments of the invention, examples of which are illustrated in the accompanying drawings. When appropriate, the same reference numbers are used throughout the drawings to refer to the same or like parts.

In some embodiments of the present application, to effectively guide a user to take high quality photos, a photo-taking template database may be provided. Template photos may be stored in the database. A template photo may contain information regarding a figure of a person shown in the template, as well as information regarding the clothing, shoes, hats, etc., worn by the person. In this way, when a user needs to take photos, the user may select a photo-taking template or a photo-taking recommendation system may recommend a photo-taking template. The user may then take photos by referencing postures of the figure of the person and/or shooting angles shown in the template.

Various methods may be used to create a photo-taking template database. For example, some relatively good photos may be collected manually in advance and then stored into the template database. On an e-commerce platform, however, creating the photo-taking template database manually may not be practical because of the large number of merchandise objects that are on sale on the platform. Manually selected photo-taking templates may be too limited to cover the broad range of merchandise objects on the platform. As used herein, a merchandise object may refer to a product, part of a product, or a combination of products that is sold or offered to sell on the e-commerce platform. A merchandise object is normally shown in a photo to attract buyers' attention. As the number of sellers of a particular merchandise object or similar merchandise objects increases, the photos of these merchandise objects may all look the same, e.g., they may be displayed in a similar way, worn by a same model, or captured with similar shooting angles. A buyer may be unable to differentiate different sellers or merchandise objects from these photos. In addition, the photos may be unable to fully display features of the merchandise objects, and tend to lead to visual fatigue. Moreover, for merchandise objects having different features, it may often be necessary to highlight the features through special postures and/or angles.

In light of the above, the present application discloses a photo-taking template database that can be created automatically based on a large number of images on an e-commerce platform. The templates in the database may be used for providing recommendation information in response to a user's photo-taking request.

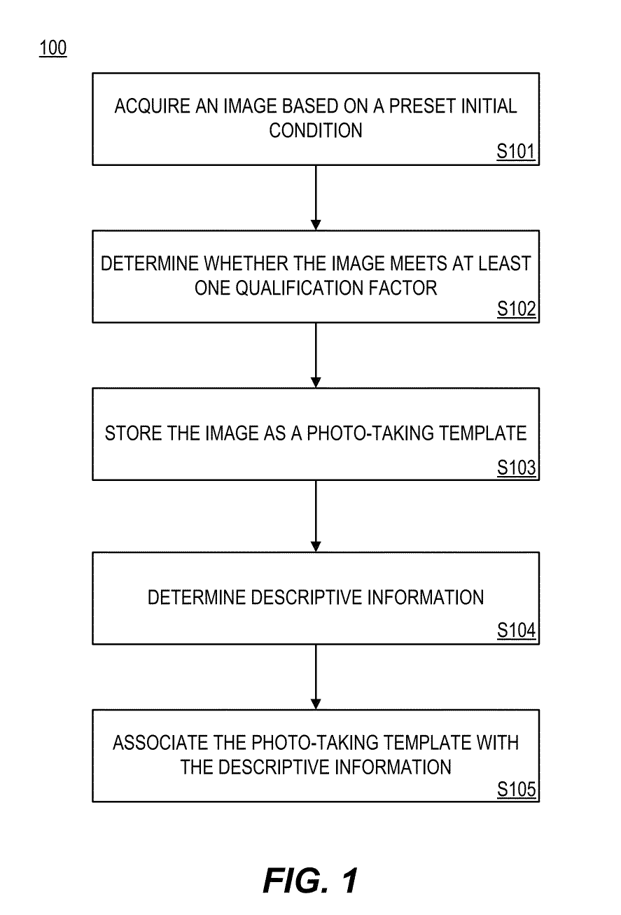

FIG. 1 is a flow chart of an exemplary photo-taking template database creating method 100. Method 100 may include multiple steps, and some steps may be optional. Method 100 may be implemented by a processor device of a computer. For example, the processor device may execute software instructions to perform the various functions described in each step.

In step S101, an image may be acquired based on a preset initial condition. For example, the preset initial condition may be that the image includes a figure of a person or a body part of a person. If the image contains such figures, then it may be acquired.

A variety of timings may exist for acquiring such an image that meets the preset initial condition. In some embodiments, a program may automatically search images of merchandise objects in a database of the e-commerce platform, which includes images of merchandise objects that are typically submitted by sellers when releasing information regarding the merchandise objects. For example, for merchandise objects in the clothing category, images submitted by sellers often contain a figure of a person, e.g., a model. The figure may be a whole body portrait of the model (usually the seller him/herself) or a body part of the model (e.g., a half body figure, a profile, or a front portrait), and may have a specific posture. These images may be used as photo-taking templates. Of course, not all merchandise objects need to be displayed through a model. Generally, only those merchandise objects that are directly attached to human body, such as clothing, shoes, hats, and accessories (e.g., necklaces, bracelets, ear rings, belts, etc.), may be suitable for display through a figure of a person. The searching of these types of images may be conducted in categories associated with clothing, shoes, hats, and accessories, thereby reducing the search scope and saving computation resources.

In some embodiments, acquisition of images may be performed when a seller submits a request for releasing merchandise objects. For example, when a seller submits information of merchandise objects to the e-commerce platform, the seller may also submit detailed descriptive information of the merchandise objects. For merchandise objects in the categories of clothing, shoes, hats, and accessories, a seller may provide images containing figures of a model, so as to display the effect of the merchandise objects while worn by the model. Therefore, such images may meet the preset initial condition and may be acquired upon receiving such product release requests. In some embodiments, upon receiving a request for releasing merchandise objects from a seller, the category information of the merchandise objects may be decided. Then, if the merchandise objects belong to the categories of clothing, shoes, hats, and accessories, images that meet the preset initial condition may then be acquired from the released information.

In addition, a portal may be provided to allow a buyer or seller to provide and upload images to an e-commerce platform via a client device. When a user finds an image suitable for being used as a photo-taking template, the user may upload the image to a server via the portal. Images may be acquired in this way.

In step S102, the processor device may determine if the image meets at least one qualification factor to qualify as a photo-taking template.

The initial condition applied in step S101 may be relatively preliminary. For example, an image may be deemed as meeting the initial condition as long as it contains a figure of a person or a body part of a person. An image meeting the initial condition, however, may not necessarily be used as a photo-taking template. Therefore, step S102 may apply further qualification factor(s) to determine if the image qualifies as a photo-taking template. In other words, images meeting the initial condition can be further screened in step S102 to obtain qualified photo-taking templates.

In some embodiments, qualification factors may be predetermined. For example, these factors may include an assessment of one or more of image background (e.g., whether the background is free from noise or whether the background contains a single color), image outline or profile of the figure of the person or body part (e.g., whether the outline/profile is clear and distinctive from surrounding areas), a position of the figure in the image (e.g., whether the figure is positioned at the center of the image), a scale of the figure with respect to the image (e.g., whether the scale is appropriate with respect to the whole image), etc. In this way, images acquired in step S101 may be further analyzed using these qualification factors to determine if any images qualify as photo-taking templates.

In some embodiments, a portal may be provided for sellers to provide designated photo-taking templates. For example, when a seller submits a request for releasing a merchandise object, one or more images may be submitted at the same time. Among these images, one or more may be designated as photo-taking templates corresponding to the merchandise object. When a server receives the release request from the seller, images designated by the user as photo-taking templates may carry marks (e.g., keywords carried in the meta data such as data head of an image) indicating that the images qualify as photo-taking templates. These marks may be used as qualification factors in determining whether each acquired image qualifies as a photo-taking template.

In step S103, after the processor device determines that one or more acquired images meet at least one qualification factor and therefore qualify as photo-taking templates, these images may be stored as photo-taking templates in the photo-taking template database. In step S104, the processor device may determine descriptive information based on information obtained from the image. For example, the descriptive information may be determined based on information relating to the object displayed in the image that qualifies as a photo-taking template.

In some embodiments, as there are a large number of sources from which images/photo-taking templates can be acquired, the resulting photo-taking template database may be of a huge size. In such a circumstance, it may not be appropriate to return all photo-taking templates in the database when a user requests a photo-taking template. To reduce the number of templates to be returned and to better match the specific needs of the user, descriptive information may be used. Such descriptive information may include information describing the object(s) displayed in a photo-taking template, and may be saved together with the photo-taking template in the database. The descriptive information may be used for template screening. When a user requests a template, some specific parameters may be included in the request transmitted to the server. These parameters may include descriptive information of an object to be pictured. Upon receiving the request, the server may automatically perform a matching operation between the descriptive information carried in the request and the descriptive information corresponding to each photo-taking template. If a target photo-taking is found (e.g., the descriptive information corresponding to the template matches or partially matches the descriptive information carried in the request), the server may return the target photo-taking template to the user (e.g., to a client device of the user).

The object displayed in a photo-taking template may include a merchandise object and/or a figure of a person or a body part of a person. Accordingly, the descriptive information of the displayed object may also refer to the descriptive information of the displayed merchandise object and/or the descriptive information of the displayed figure. Exemplary methods to acquire the descriptive information of the object displayed in a photo-taking template and other contents will be described in greater detail below with reference to step S104.

In step S104, the processor device may determine the descriptive information based on information obtained from the acquired image. In step S105, the processor device may associate the photo-taking template with the descriptive information and store the descriptive information in the database.

When an image is determined to meet a qualification factor and qualify as a photo-taking template, and its associated descriptive information has been determined, the image may be saved as a photo-taking template into the photo-taking template database, and the corresponding relation between the photo-taking template and the descriptive information may also be saved in the database. When a request for acquiring a photo-taking template is received, matching operation may be performed between the parameters (e.g., includes descriptive information of the object to be pictured) carried in the request and the descriptive information of each template in the database. Matched photo-taking template may be used to provide recommendation information.

The descriptive information of a photo-taking template may be determined in many ways. In addition, the corresponding relation associating the template and its corresponding descriptive information may be of many kinds. Exemplary methods of determining the descriptive information will be described below in greater detail.

In some embodiments, the descriptive information of a photo-taking template may be expressed through the descriptive information of a merchandise object displayed in an image. For example, upon receiving a request for acquiring a template from a client, if the parameters carried in the request include the descriptive information of the merchandise object to be pictured, it can be decided which template(s) has descriptive information matching the descriptive information, and then the matching template may be returned to the client.

Descriptive information of the merchandise object displayed in the image may also be of different kinds. For example, an e-commerce platform usually assigns an ID to each merchandise object. Therefore, the ID may be used as the descriptive information of the merchandise object. In this case, a specific template may have a corresponding relation with a merchandise object. Such a corresponding relation may be either one to one, i.e., one merchandise object corresponds to one template, or one to multiple, i.e., one merchandise object corresponds to multiple templates.

For example, in the case of a one-to-one relation, data stored in the database may be organized as shown in Table 1:

TABLE 1

| | Template | Merchandise |
|---|---|---|
| Template No. | data | object ID |
| Template_001 | Data 1 | 100010 |
| Template_002 | Data 2 | 100011 |
| Template_003 | Data 3 | 100012 |
| Template_004 | Data 4 | 100013 |
| . . . | . . . | . . . |

Template data may refer to data for displaying template images. When a client transmits a request for acquiring a template, the request may carry the ID of the merchandise object to be pictured. When a server receives the request, it may search for the template corresponding to the ID in the database shown in Table 1. If the ID is found, the server may determine that the template corresponding to the ID is the target template, and then return target template. In a one-to-multiple situation, where one merchandise object ID corresponds to multiple templates, the multiple templates may all be provided to the client to allow the user to choose one as the target template.

In another example, an e-commerce platform may usually provide information regarding categories that merchandise objects belong to. The classification of the categories may further have hierarchical relations, e.g., a big merchandise category may be classified into many sub-categories. For example, the category of clothing may be classified into women's clothing, men's clothing, children's clothing, etc. The category of women's clothing may further comprise a number of subcategories, such as one-piece dresses, short sleeves, pants, coats, down jackets, etc. In addition to the above categories classified according to functions, category classification may be made according to fashion, style, material, etc. During photo taking, photos of merchandise objects in the same category may have higher value as reference than those in different categories. Therefore, the category to which the merchandise object belongs may also be used as the descriptive information of a photo-taking template.

A template database including category information may have the structure shown in Table 2:

TABLE 2

| | Template | Merchandise object |
|---|---|---|
| Template No. | data | category |
| Template_001 | Data 1 | short skirt |
| Template_002 | Data 2 | one-piece dress |
| Template_003 | Data 3 | coats |
| Template_004 | Data 4 | pants |
| . . . | . . . | . . . |

When a client needs to acquire a template, the request transmitted to the server may carry the information regarding the category of a merchandise object to be pictured. When the server receives the request, the server may extract the category information from the request, and then match with the category information corresponding to each template in Table 2. The template corresponding to the matched category may be returned to the client as the recommended template.

In a further example, merchandise objects sold by the same seller often have some similarities in terms of fashion and other aspects. For example, apparels in a clothing brand flagship store are typically similar to each other in design and fashion style. Therefore, images of merchandise objects sold be a same seller may also have relatively high value as photo-taking references. To utilize such information, the identity information of a seller of a merchandise object may also be used as the descriptive information of a photo-taking template. When templates are searched subsequently, the identity information of the seller may be used for matching parameters carried in the request. A template database including the selling information may have the structure shown in Table 3:

TABLE 3

| | Template | |
|---|---|---|
| Template No. | data | Identity information of seller |
| Template_001 | Data 1 | ID, account number, etc. of seller A |
| Template_002 | Data 2 | ID, account number, etc. of seller B |
| Template_003 | Data 3 | ID, account number, etc. of seller C |
| Template_004 | Data 4 | ID, account number, etc. of seller D |
| . . . | . . . | . . . |

When a client needs to acquire a template, the request transmitted to the server may carry the identity information of a seller of a merchandise object to be pictured. When the server receives the request, it may return a matching template according to the ID, account number, and/or other data of the seller.

If images are acquired by means of active search in an e-commerce platform database, these images may be images corresponding to the released merchandise objects. The template database may then save the descriptive information of merchandise objects (e.g., ID, category, identity information of sellers, etc.) together with the images. If images are acquired by means of uploading by a user, then the descriptive information of merchandise objects may be acquired from the information submitted by the user. When the user is a seller, the seller may submit an image during the process of releasing a merchandise object, when the merchandise ID may still be unavailable (e.g., the merchandise ID may not be assigned to the merchandise object before the actual execution of a release operation). In this case, the descriptive information of the merchandise object may be acquired through the information (e.g. name or introduction of the merchandise object) submitted by the seller. When the platform assigns an ID to the merchandise object and classifies the merchandise object into a specific category, the descriptive information may then be updated.

In the above description, the descriptive information of merchandise objects displayed in an acquired image is used as the descriptive information of the corresponding photo-taking template if the acquired image qualifies as a template. In some embodiments, images qualified as templates may also include a figure of a person or a body part in addition to the merchandise objects. If, for example, a model to be pictured is similar to the figure of the template in terms of body size and other aspects, then a good photo may be obtained if the model takes a similar pose to the figure and the photo is taken using a similar shooting angle. In other words, the template may serve as a guide to instruct the user to take a similar photo to the template. In this case, descriptive information of the figure in the template (e.g., gender, height, weight, etc.) may also be acquired to use as the descriptive information of the photo-taking template. Such descriptive information may be used for template matching. A template database including such information may be structured as shown in Table 4:

TABLE 4

| | Template | Descriptive information of figure |
|---|---|---|
| Template No. | data | features |
| Template_001 | Data 1 | sex1/height1/weight1/ . . . |
| Template_002 | Data 2 | sex1/height2/weight2/ . . . |
| Template_003 | Data 3 | sex1/height3/weight3/ . . . |
| Template_004 | Data 4 | sex2/height4/weight4/ . . . |
| . . . | . . . | . . . |

When a client needs to acquire a template, the request transmitted to the server may carry the descriptive information of a person (e.g., a model) to be pictured. When the server receives the request, it may search for a matching template according to information associated with a figure of a person, such as gender, height, weight, etc. In addition, because body size data are typically expressed by numerical values, the degree of matching, or the similarity, between the model and figure in the template in terms of the body size may be obtained by calculating, e.g., distances between vectors (e.g., numerical body size data may be expressed as a vector and the similarity between two vectors may be calculated based on the distance between the two vectors).

Descriptive information of a figure in the template may be provided by a user when submitting the image, such as the image submitted by a seller during release of a merchandise object, or the image submitted by any user for providing a photo-taking template). For images automatically found by searching in an e-commerce platform, descriptive information of a figure may be obtained from information of the merchandise object. This is because these images may be originally uploaded by sellers while releasing the merchandise object, and the seller may probably also submit body size data of models in the images, for example, for buyers' reference. Therefore, the database of the platform may record the body size data. When images having a figure of a person are acquired from the platform database by means of searching, the body size data of the figure may be obtained from the database of the platform as the descriptive information of the corresponding photo-taking templates.

In the above description, several forms of descriptive information of photo-taking templates are disclosed, and exemplary data storage methods of the corresponding template database are provided. In some embodiments, two or more types of information may be combined as the descriptive information of photo-taking templates. Moreover, different templates in the same template database may contain descriptive information in different aspects. For example, one template may contain descriptive information of merchandise objects. Another template may contain both descriptive information of merchandise objects and body size data of a person. When descriptive information contains multiple aspects, any combination of these aspects may be used during a matching operation. For example, different aspects may be combined using an “AND” logic. In this case, a matching template is found only when both aspects connected by the AND logic match the information in a request. Alternatively or additionally, different aspects may be combined using an “OR” logic. In this case, a matching template is found when any one of the aspects matches the information in a request.

In sum, the sources of images can be abundant for creating templates, which provides a solid data foundation for meeting user demand in many aspects when shooting photos. Moreover, matching operations may be automatically performed using descriptive information of each template according to the user demand, and a matched or partially matched template can be returned.

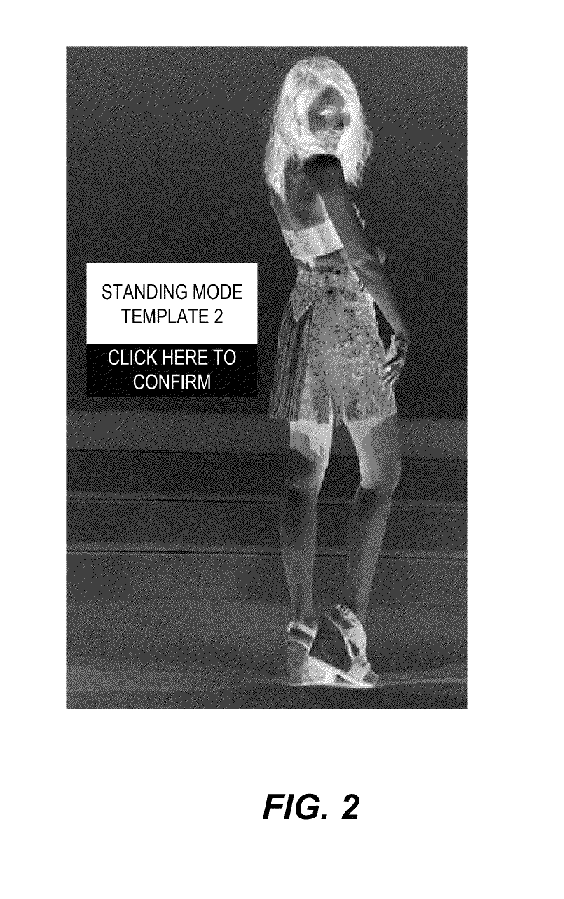

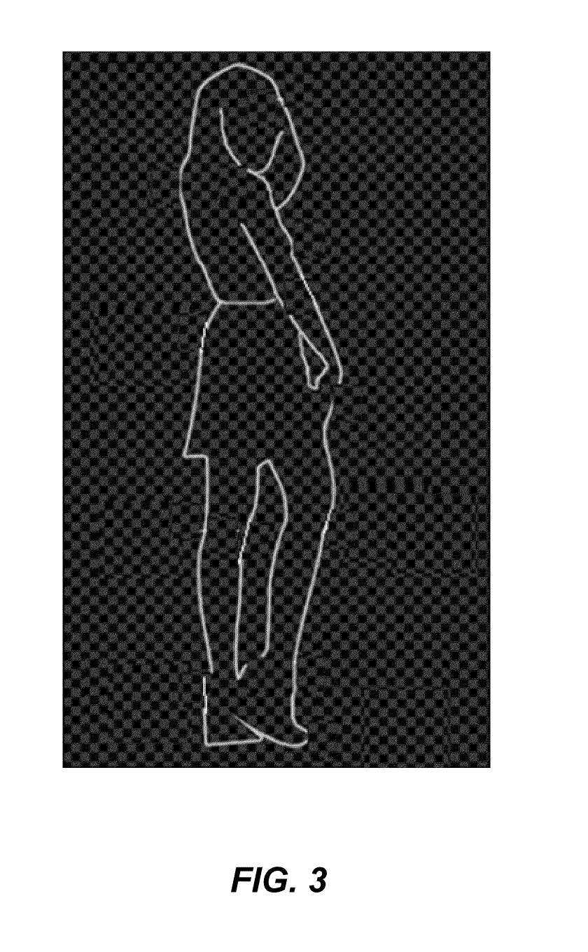

In addition, to highlight features of a figure in a photo-taking template, the body profile curve of the figure may be identified or extracted from the template. The profile curve may be identified when the template is stored in the template database. The profile curve may also be stored in the template database. The profile curve may be a curve portrayed according to the figure in the template. For example, for a photo-taking template shown in FIG. 2, the body profile curve of the figure may be identified, as shown in FIG. 3.

In some embodiments, when template images and corresponding descriptive information are stored in the template database, the profile curve of the figure may be identified. Position information of the profile curve may then be determined and stored in the template database. An exemplary storage structure of the template data in the database is shown in Table 5 (assume that the descriptive information of merchandise objects is used as a search condition).

TABLE 5

| | | Descriptive | |
|---|---|---|---|
| | | information of | |
| | Template | displayed | |
| Template No. | data | merchandise objects | Body profile curve |
| Template_001 | Image 1 | class1 | Information of Curve 1 |
| Template_002 | Image 2 | class2 | Information of Curve 2 |
| Template_003 | Image 3 | class3 | Information of Curve 3 |
| Template_004 | Image 4 | class4 | Information of Curve 4 |
| . . . | . . . | . . . | . . . |

Many methods may be used to store the information of body profile curve in the template database. For example, when a body profile curve has been identified and extracted, the coordinates of each pixel on the curve may be determined, and these coordinates may be used to describe or represent the curve. Alternatively or additionally, the curve may be described or represented by means of functions, vectors, etc.

In this way, when a use chooses one of the template images as reference, the choosing action may activate a photo-taking device to capture a live image. The live image may be displayed on an interface of a terminal device, such as a smart phone. A recommendation profile curve overlaid with the live image may be displayed based on the position information. For example, an image layer may be created on the top layer of the captured live image. On the image layer, the curve described in Table 5 may be shown in color (e.g., black), while other parts may be transparent. In this way, a user can see a body profile curve on the top layer of the photo image, while other image contents will not be shielded. The user may match the body profile curve shown on the interface by continuously changing the pose of himself/herself until the user observes that his/her own pose fits the body profile curve shown on the interface. It shows that the user has the same or similar pose to the figure in the template, which may be able to achieve good photo-taking effect.

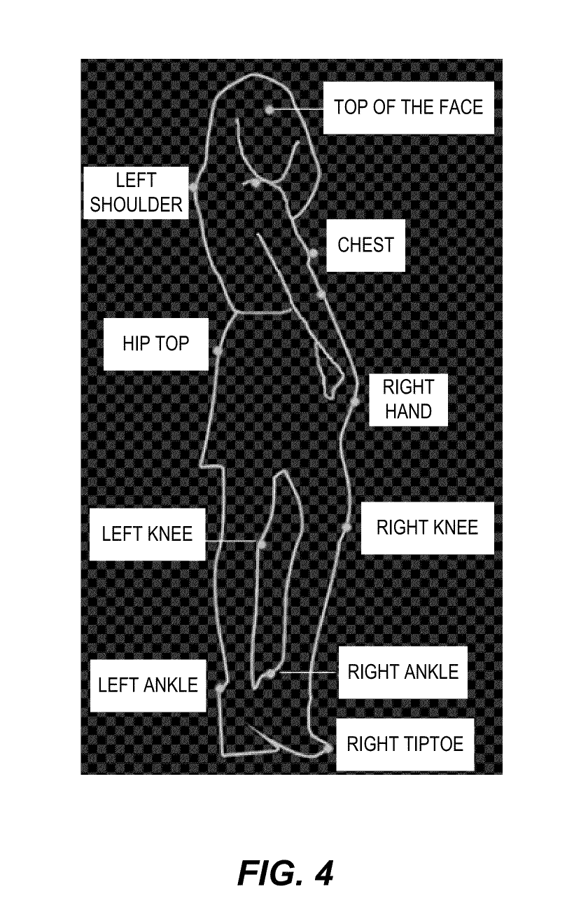

In addition, to better determine the position of each body part during the photo-taking process, when the body profile curve of the figure is shown on the top layer of the image, indications of body parts may be marked on the body profile curve. For example, as shown in FIG. 4, indications such as top of the face, left shoulder, chest, hip top, right hand, etc. may be marked close to the appropriate positions of the profile curve, which can guide the user to make adjustments in a more intuitive way. For different templates, different body parts may be marked. In some embodiments, positions of body parts of the figure in each template image may be analyzed and stored in the template database. In this case, in addition to storing the information of body profile curves, the database may also store indications and corresponding coordinates of one or more body parts. For example, an exemplary storage structure is shown in Table 6 (assume that the descriptive information of merchandise objects is used as the search condition).

TABLE 6

| | | Descriptive | | |
|---|---|---|---|---|
| | | information | | |
| | | of displayed | Body | Relative |
| | Template | merchandise | profile | positions |
| Template No. | data | objects | curve | of body parts |
| Template_001 | Image 1 | class1 | Informa- | Part 1: coordinate |
| | | | tion of | 1; Part 2: |
| | | | Curve 1 | coordinate 2/. . . |
| Template_002 | Image 2 | class2 | Informa- | Part 1: coordinate |
| | | | tion of | 1; Part 2: |
| | | | Curve 2 | coordinate 2/. . . |
| Template_003 | Image 3 | class3 | Informa- | Part 1: coordinate |
| | | | tion of | 1; Part 2: |
| | | | Curve 3 | coordinate 2/. . . |
| Template_004 | Image 4 | class4 | Informa- | Part 1: coordinate |
| | | | tion of | 1; Part 2: |
| | | | Curve 4 | coordinate 2/. . . |
| . . . | . . . | . . . | . . . | . . . |

In this way, when displaying a body profile curve, a user may read indications of the body parts marked at the corresponding positions on the curve. The user may determine how to move or place each body part intuitively according to the indications, which can help the user mimic the pose of the model in the template.

The above description discloses methods of creating a template database. After the template database is created, it may be provided for inquiries by client terminals in various application scenarios. In one application, a buyer may provide evaluation information for the merchandise objects purchased and may upload photos of the merchandise objects. For example, when the merchandise objects are apparels, shoes, hats, etc., the buyer may wish to take photos after trying on the merchandise object, for example, with the merchandise object worn on. The photos may be submitted to the server as part of the evaluation information, which may be used for reference by other buyers. The template database disclosed herein may be used to provide recommendation information, such as postures or shooting angles to assist the buyer to take good photos.

Another application may involve a seller. When the seller releases information of merchandise objects such as clothing, shoes, hats, accessories, etc., the seller may typically provide photos of these merchandise objects worn by a model to show the features or effects. The template database disclosed herein may be used to provide photo-taking templates to the seller, so as to help the seller take photos of the merchandise objects that can better display features or effects of the merchandise objects.

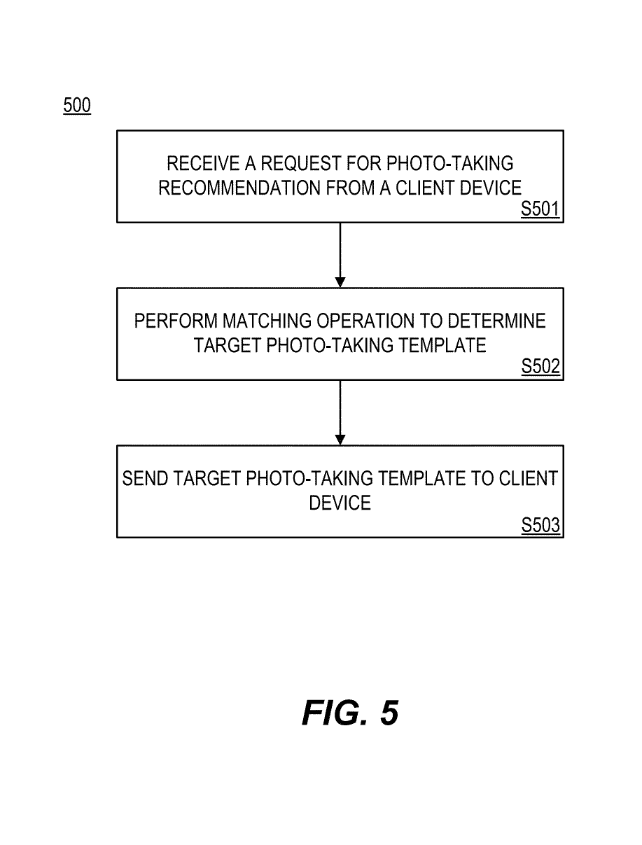

FIG. 5 is a flow chart of an exemplary method 500 for providing photo-taking recommendation information. Method 500 may be implemented by a server. The sever may store a template database in a memory device. A plurality of photo-taking templates and their associated descriptive information may be stored in the template database. The descriptive information of a photo-taking template may be associated with information of one or more objects in the photo-taking template. Method 500 may include several steps, some of which may be optional.

In step S501, the server may receive a request for photo-taking recommendation from a client device. The request may include descriptive information of an object to be captured by a photo-taking device.

The object to be captured may include a merchandise object to be pictured and/or a person or a body part of the person to be pictured. The descriptive information of the object may include the descriptive information of the merchandise object and/or the descriptive information of the person or the body part of the person. The descriptive information of the merchandise object may include information such as merchandise object ID, category, style/fashion/material, identification of the seller of the merchandise object. The descriptive information of the person or the body part of the person may include the gender information and body size data, such as height and weight, of the person to be pictured. In some embodiments, the request may carry one or more types of the above disclosed descriptive information.

In step S502, the server may perform matching operation between the descriptive information of the object to be pictured and the descriptive information associated with each photo-taking template in the template database.

When the descriptive information of the object to be pictured is acquired, the descriptive information of the object to be pictured may be used to match the descriptive information associated with each photo-taking template. The matching operation may be carried out according to gender and body size data of the person to be pictured, the descriptive information of the merchandise object such as the category of the displayed merchandise object, or a combination thereof. When the descriptive information of the person or the body part of the person includes a plurality of data fields, each data field may be used to match a corresponding data field in the database. For example, the body size data of a male model may include a plurality of data fields such as height, weight, shoulder width, leg length, and waist circumference, each of these body size data may be used to match the corresponding body size data stored in the template database, so as to select a photo-taking template that is close to the body size of the person to be pictured. In some embodiments, not all body size data are used for matching. When searching for a target photo-taking template that matches the body size data of the person to be pictured, the difference between each of the body size data of the person to be pictured and the body size data stored in the database may be calculated, so as to obtain a relative difference or, a similarity, between the two. The target photo-taking template may be the one that has the smallest relative difference (or the highest degree of similarity). In some embodiments, the target photo-taking template may be a template that has the relative difference smaller than a preset threshold value.

In step S503, the server may return the target photo-taking template to the client device so that the client device may provide photo-taking recommendation information based on the target photo-taking template.

Exemplary implementations of steps S502 and S503 under normal condition have been described above in connection with FIGS. 1-4. The normal condition refers to when a fully matched template can be found in the template database based on the descriptive information of the object to be pictured carried in the request. For example, the request may carry an ID of a merchandise object to be pictured, and a template that matches the exact ID can be found in the template database. In practice, however, an exact match may not always occur. For example, the request may carry an ID of a merchandise object to be pictured, but no template can be found in the template database having the exact ID. In this case, the server may provide a template based on other measures. For example, the identity information of the seller may be determined according to the ID of the merchandise object. A target template matching the identity of the seller may be found in the template database and returned to the client device. Other types of partial matching schemes may also be used. In sum, when a request carries a first descriptive information of an object to be pictured, if no matched template can be found in the template database, then a second descriptive information of the object to be pictured may be acquired according to the first descriptive information. The template database may be searched for a matching template based on the second descriptive information.

If the template database also stores the information regarding body profile curve of the figure of a person contained in the photo-taking template, the server may also return such information to the client device. In this way, when the client device provides photo-taking recommendation information, it may also provide the information regarding body profile curve to the user.

In addition, if the template database also stores indications and coordinates of one or more body parts of the figure contained in the photo-taking template, the server may also returned such information to the client device. When displaying a body profile curve, indications of these body parts may also be displayed on the curve at their proper positions according to the coordinates. In this way, the user may determine how to place each body part in an intuitive way to mimic the posture of the figure in the template.

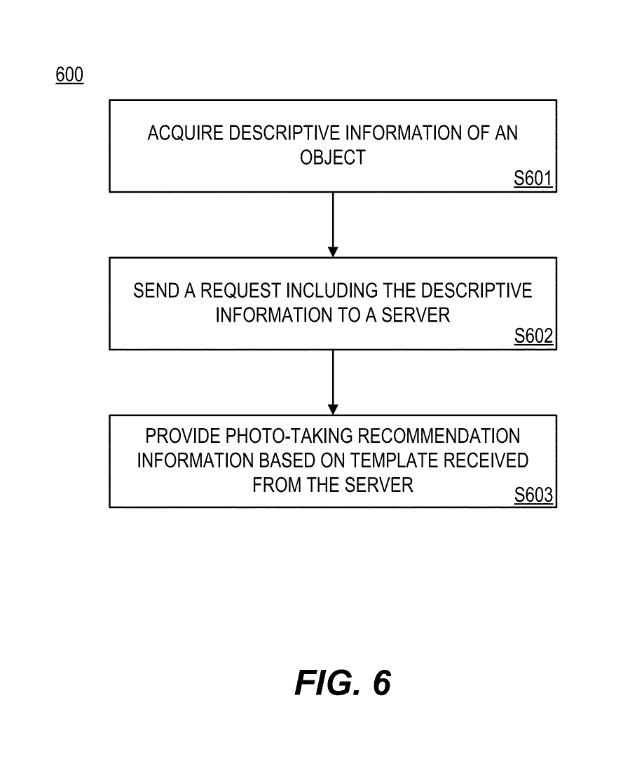

While FIG. 5 discloses method 500 for providing photo-taking recommendation information implemented by a server. FIG. 6 shows a method 600 for providing photo-taking recommendation information implemented by a client device.

In step S601, the client device may acquire descriptive information of an object to be pictured.

In some embodiments, the object to be pictured may include a merchandise object to be pictured and/or a person wearing the merchandise object. Descriptive information of the merchandise object and descriptive information of the person may be acquired together or separately. In some embodiments, only one type of the descriptive information may be acquired.

The descriptive information of an object may be submittal by a user who initiates the photo-taking request. For example, a portal (e.g., an input box, a selection box, a button, etc.) may be provided for the user to submit the descriptive information of the object to be pictured on a user interface. When a request for obtaining a photo-taking template is made, the user may submit the descriptive information of the object to be pictured via the portal.

In some embodiments, automatic or semi-automatic acquisition of the descriptive information of the object to be pictured may be provided. For example, in case a buyer wishes to show a purchased merchandise object, the buyer may do so during an evaluation process. In some embodiments, the evaluation process may be during or after an operation to confirm receipt of goods. The buyer may need to upload a photo showing the effect of the merchandise object worn by a model (e.g., the user him/herself or other person). Accordingly, a first portal (e.g., a button, etc.) for submitting a photo may be provided to the user on an interface associated with a purchase order of the merchandise object. In this way, upon receiving a request for uploading a photo submitted by the user, method 600 may be performed. Moreover, various descriptive information of the merchandise object, including ID, category, identity information of the seller, etc., may be acquired from an associated purchase order, which may be used as the descriptive information of the object to be pictured. When the object includes a person or a body part of the person, various methods to acquire the descriptive information of the person may be used. For example, the user may be asked to input data of the person to be pictured, such as gender and body size data. In another example, when the person to be pictured is a registered user in an e-commerce platform, the identity information of the person to be pictured may be submitted. Information about the person may be automatically acquired based on the registration information or evaluation history. For example, if a user evaluated a merchandise object in the past, the user might have input his/her body size information, such as height and weight to the platform, and the database of the platform may have recorded such information. Therefore, the user's body size information may be acquired through historic evaluation data recorded in the database. Accordingly, once the identity information of the person (e.g., user ID) is acquired, the server may automatically acquire the user information, such as gender, height and weight, according to the identity information. Upon receiving a request for uploading a photo, the photo and the identification information of the purchase order may be uploaded to the server. In this a way, the sever may extract the identification information of the merchandise object from the purchase order, and record the relationship between the photo and the identification information of the merchandise objects. The information may be used for displaying the photo in the evaluation interface of the merchandise object.

In case a seller provides images for a merchandise object to be released, descriptive information may also be obtained. For example, a second portal for submitting photos may be provided in a merchandise object information release interface. In this way, upon receiving a photo-submitting request by the seller of the merchandise object, method 600 may be performed. Information about the merchandise object may have been input in the information release interface via the second portal. The descriptive information of the merchandise object to be pictured may be acquired from the descriptive information of the merchandise object already input in the merchandise object information release interface. Alternatively, a portal may be provided to the seller to provide the descriptive information of the merchandise object to be pictured. The descriptive information of the person may be acquired similar to the above-described application with respect to a buyer. Upon receiving a request for uploading a photo, the photo and the identification information of the merchandise objects to be released may be uploaded to the server. In this way, the sever may store the relationship between the photo and the identification information of the merchandise objects. The information may be used for displaying the photo in the product information page of the merchandise objects.

In addition, an editing interface of merchandise object information may be provided for the seller when a merchandise object has already been released. Through the editing interface, the seller may add or edit photos and other information for the released merchandise object. In some embodiments, a third portal for submitting photos may be provided in the information editing interface associated with the released merchandise object. In this way, a photo-submitting request by the seller for a released merchandise object may be received via the third portal, and method 600 may be performed. The descriptive information of the released merchandise object may be obtained from the server and used as the descriptive information of the merchandise object to be pictured. Alternatively, a portal may be provided for the seller to provide the descriptive information of the merchandise object to be pictured. The descriptive information of a person may be acquired similar to the above-described application with respect to a buyer. Upon receiving a request for uploading photos, the photos and the identification information of the released merchandise objects may be uploaded to the server. The sever may store the relationship between the photos and the identification information of the merchandise objects. The information may be used for displaying the photos in the product information page of the merchandise objects.

In step S602, a request for photo-taking recommendation may be sent to a server. The request may include the descriptive information, such that the server may perform matching operation between the descriptive information of the object to be pictured and the descriptive information of each photo-taking template in the template database to obtain a target photo-taking template.

In step S603, the client device may provide photo-taking recommendation information based on the target photo-taking template returned by the server. The photo-taking template may be associated with descriptive information of one or more figures included in the photo-taking template. The descriptive information associated with the photo-taking template may at least partially match the descriptive information of the object to be pictured.

Upon acquiring one or more target templates, all suitable photo-taking templates may be displayed to the user in an interface, and a selection portal (e.g. a button, etc.) may be provided to the user. The user may select a desired template. For example, if a user wants to upload photos of herself while trying on a short skirt, the user may select one of the templates according to her own body size and the category of the clothing merchandise. A target photo-taking template may be selected from the database according to the selection result of the user.

When the target photo-taking template is determined, the client device may automatically activate a photo-taking device (e.g., equipped on the user's terminal device). The image interface on the user's terminal device may display live images captured by the photo-taking device. In some embodiments, a profile curve of the figure of the person in the target photo-taking template may be displayed on the image interface. The profile curve may be used as a recommendation profile curve overlaid with the live images based on position information of the profile curve. For example, for a photo-taking template shown in FIG. 2, an exemplary profile curve of the person shown in FIG. 2 may be the one as shown in FIG. 3 (the live images captured by the photo-taking device are not shown in FIG. 3). The profile curve may be displayed on a top layer of the image. In this way, the user may see the curve, but can only see the line of the curve. The user may normally see the live images captured by the photo-taking device, including those inside and outside the region of the curve.

The profile curves may be identified and extracted in advance and stored in the template database, as shown in Table 5. When a profile curve is displayed, an image layer may be created on the top layer of the image. On the image layer, the corresponding curve in Table 5 may be shown in color (e.g. black), while other parts may be transparent. In this way, a user can see a profile curve on the top layer of the live image, while other image contents of the live image will not be shielded.

In some embodiments, profile curves of the templates may be extracted when it is to be displayed. In other words, when the target photo-taking template has been determined and the photo-taking device has been activated, the profile curve may be extracted from the template.

When the user adjusts the shooting angle of the terminal device, the coordinates of the profile curve displayed on the top layer of the live image may remain unchanged relative to the screen of the terminal device. The user may match the profile curve displayed on the interface by continuously changing his/her own pose until the user observes that his/her own pose fits the profile curve shown on the interface. It indicates that the user has the pose the same as, or at least similar to, the person in the template.

In some embodiments, the position of a photo-taking device on a terminal device may vary. For example, a mobile device may have a front camera and a rear camera. The photo-taking device disclosed herein may include both the front and rear camera. When the front camera is used, the user may take selfies and may make adjustments on his/her own. If a rear camera is used, another person may be needed to guide the user to be pictured to make adjustments. For example, the adjustments may be based on the profile curve displayed on the top layer of the live image.

In some embodiments, to better determine the position of each body part during a photo-taking process, indications of one or more body parts may be marked on the corresponding positions of the profile curve. For example, as shown in FIG. 4, indications such as top of the face, left shoulder, chest, hip top, right hand, etc. are shown, which can guide the user to be pictured to make adjustments in an intuitive way. The position information of these body parts may be stored in the template database in advance, as shown in Table 6.

When it is determined that a user needs to carry out a photo-shooting operation, the photo-taking device may shoot a photo and upload the photo to the server. In case a buyer shows a purchased merchandise object, the server may save the corresponding relation between the photo and the merchandise object contained in a corresponding purchase order. In case a seller releases information regarding a merchandise object, the server may add the photo to the product information of the corresponding merchandise object so as to display in the product information page.

In some embodiments, the searching for a photo-taking template may be carried out after the photo-taking device has been activated. Alternatively, the searching for a photo-taking template may be carried out before the photo-taking device is activated.

Various methods may be used to determine if a user needs to carry out a shooting operation. For example, the user may manually press the shooting button on the terminal device after the user finishes the adjustment according to the profile curve, which indicates that the user needs to carry out a shooting operation. This may be suitable for the situation in which a rear camera is used and help from others is available. For taking selfie photos with a front camera, however, manually pressing a button may affect the pose if the user him/herself needs to operate the shooting button. Accordingly, an automatic method may be provided in which a processor device may automatically determine if it is necessary to carry out a shooting operation. In other words, the user may not need to manually operate the shooting button. Rather, the processor device may determine whether a shooting operation can be carried out.

The processor device may be configured to identify the main image body in the object to be pictured. For example, when a figure of a person appears in the shooting field of view, the processor device can automatically identify the person to be the main image body. In some embodiments, a figure of a person may be set as the main image body to be pictured in advance, and the figure's moving state may be identified. In the process of pose adjustments by the user, the figure will be in a moving state. After the adjustments, the user may typically remain still. Therefore, the processor device can identify that the main image body remains in a relative still state. When the main image body remains in the still state for a preset period of time, the processor device may automatically determine that it is necessary to carry out a shooting operation.

In another example, the captured profile curve of the main image body may be extracted in real time, and the degree of similarity between the profile curve of the captured main image body and the profile curve of the target photo-taking template may be determined in real time. If the degree of similarity between the two reaches a threshold value, which indicates that the user has had a relatively suitable pose, the processor device may determine that it is necessary to carry out a shooting operation. This automatic shooting operation may be suitable for the situation in which a rear camera is used and help from others is available. For example, a helper assisting the shooting may help the person to be pictured make adjustments, and when the adjustments are finished, the shooting operation may be triggered automatically.

In sum, a plurality of photo-taking templates may be set in advance. When it is necessary to take photos, a target photo-taking template can be determined, and then the photo-taking device may be activated. Moreover, a profile curve of the template may be shown on top of the captured live images. A user may adjust his/her posture according to the curve to achieve good photo-taking effect. Taking good photos may motivate the user to upload more photos and provide more feedbacks for other users when selecting corresponding merchandise objects.

In some embodiments, some users may not want other users to see their real faces when uploading photos. Accordingly, a portal for shielding the facial area may be provided. A user may manually process the generated photos and create mosaic on the facial area. Alternatively, a processor device may automatically identify the facial area of a person in the photo, shield the facial area, and then save the processed photo. With respect to the function of automatic facial area shielding, an selection may be provided to the user to allow the user to decide whether to activate the function.

When taking photos, if the background has a color very similar to the clothes, the resulting photos may not have a good appearance, or may lack highlights of the features of the merchandise to be displayed. In some embodiments, the main color of the main image body and the main color of the background in the generated photos may be identified, and the similarity between the two may be calculated. If the similarity between the main color of the main image body and the main color of the background reaches a preset threshold value, the main color of the background may be replaced. The main color of the background after the replacement may be determined according to the main color prior to the replacement. For example, the corresponding relation between main colors before and after the replacement may be set in advance. When replacement is needed, the corresponding relation may be queried to determine what color to replace the main color of the background.

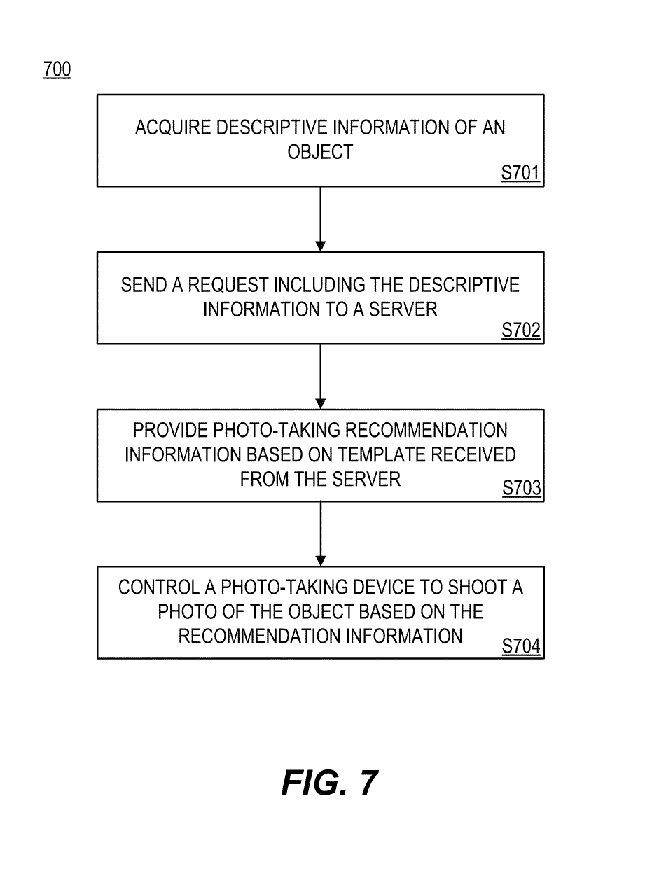

FIG. 6 discloses a method that can be implemented by an auxiliary device to a photo-taking device (e.g., a processor device couple to the photo-taking device, which may be installed on a terminal device such as a camera and a cell phone). FIG. 7 shows a method 700 for providing photo-taking recommendation information that can be implemented by a device integrated with the photo-taking device. Method 700 is similar to method 600 (e.g., steps S701, S702, and S703 are similar to steps S601, S602, and S603, respectively), expect that method 700 may include step S704, in which a processor device may control an integrated photo-taking device to shoot a photo base on the recommendation information.

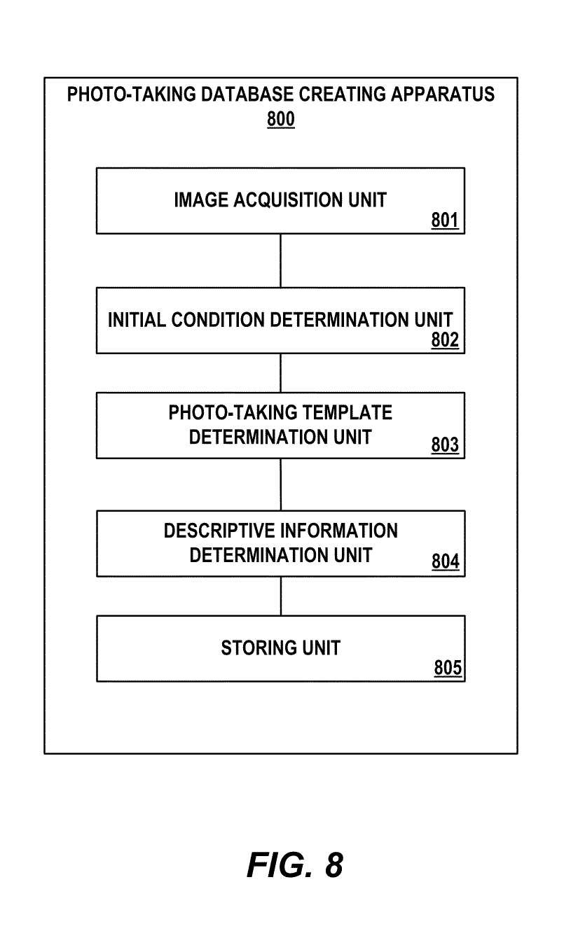

Corresponding to method 100 for creating a photo-taking template database, FIG. 8 shows a functional schematic diagram of an exemplary apparatus 800 to implement the functions of method 100. Apparatus 800 may include an image acquisition unit 801, an initial condition determination unit 802, a photo-taking template determination unit 803, a descriptive information determination unit 804, and a storing unit 805.

Image acquisition unit 801 may be configured to acquire an image, as discussed above in connection with FIGS. 1-4.

Initial condition determination unit 802 may be configured to determine if the image meets the initial condition, as discussed above in connection with FIGS. 1-4.

Photo-taking template determination unit 803 may be configured to determine if the image meets at least one qualification factor, as discussed above in connection with FIGS. 1-4.

Descriptive information determination unit 804 may be configured to determine descriptive information of the photo-taking template based on information obtained from the image and to associate the photo-taking template with the descriptive information, as discussed above in connection with FIGS. 1-4.

Storing unit 805 may be configured to store the photo-taking template and its associated descriptive information.

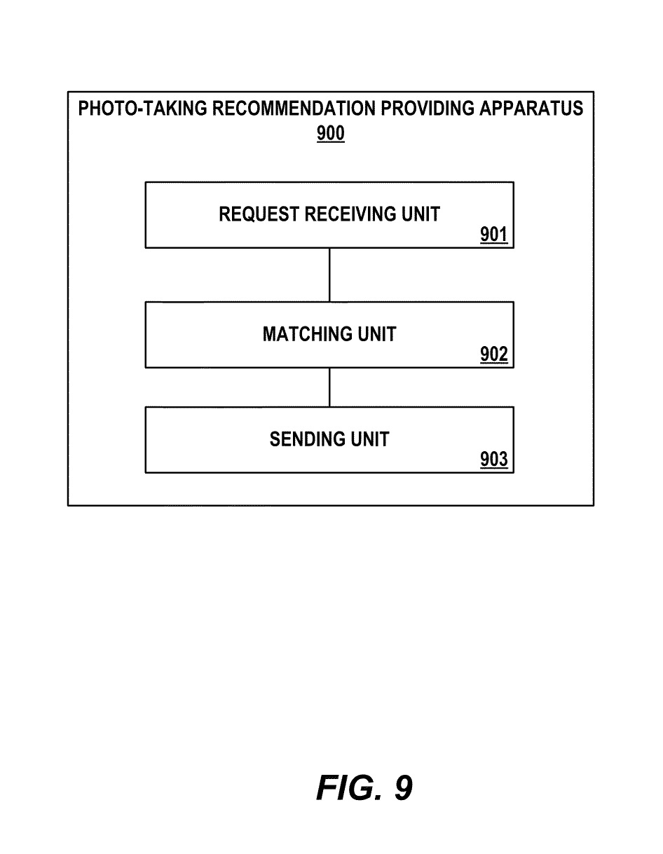

Corresponding to method 500 for providing photo-taking recommendation information, FIG. 9 shows a functional schematic diagram of an exemplary apparatus 900 to implement the functions of method 500. Apparatus 900 may include a request receiving unit 901, a matching unit 902, and a sending unit 903.

Request receiving unit 901 may be configured to receive a request for photo-taking recommendation from a client device, as discussed above in connection with FIG. 5.

Matching unit 902 may be configured to perform matching operation between the descriptive information of the object to be captured and the descriptive information associated with each photo-taking template in the template database, and to determine whether a target photo-taking template is found, as discussed above in connection with FIG. 5.

Sending unit 903 may be configured to send the target photo-taking template to the client device, as discussed above in connection with FIG. 5.

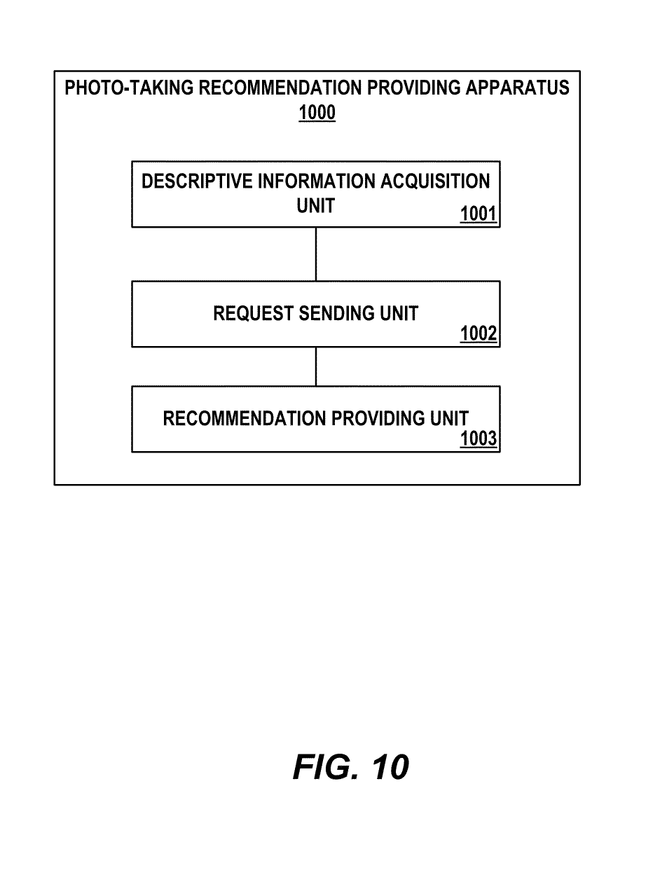

Corresponding to method 600 for providing photo-taking recommendation information, FIG. 10 shows a functional schematic diagram of an exemplary apparatus 1000 to implement the functions of method 600. Apparatus 1000 may include a descriptive information acquisition unit 1001, a request sending unit 1002, and a recommendation providing unit 1003.

Descriptive information acquisition unit 1001 may be configured to acquire descriptive information of an object to be captured by a photo-taking device, as discussed above in connection with FIG. 6.

Request sending unit 1002 may be configured to send a request for photo-taking recommendation to a server, as discussed above in connection with FIG. 6.

Recommendation providing unit 1003 may be configured to provide photo-taking recommendation information based on the target photo-taking template returned by the server, as discussed above in connection with FIG. 6.

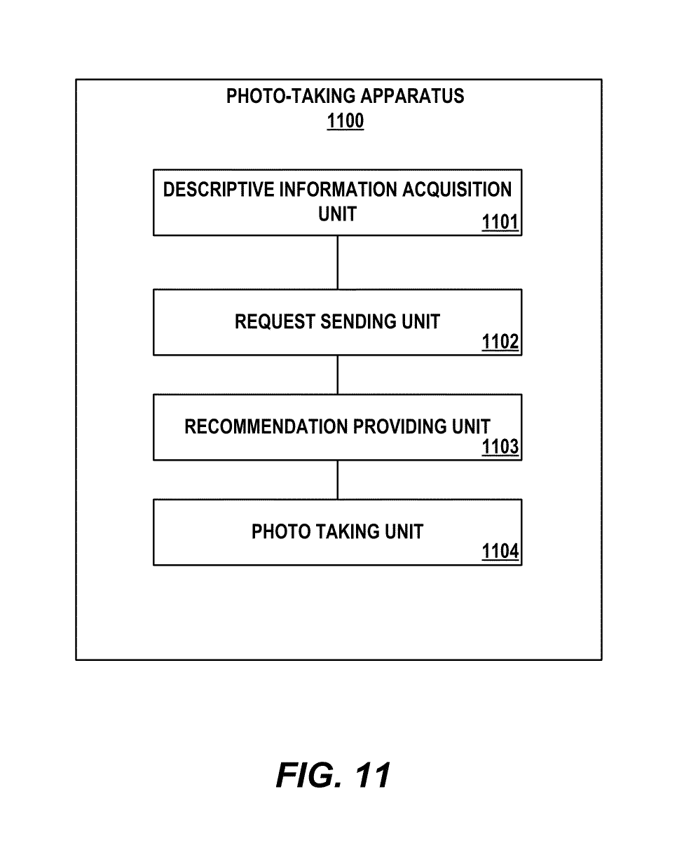

Corresponding to method 700 for providing photo-taking recommendation information, FIG. 11 shows a functional schematic diagram of an exemplary apparatus 1100 to implement the functions of method 700. Apparatus 1100 may include a descriptive information acquisition unit 1101, a request sending unit 1102, a recommendation providing unit 1103, and a photo-taking unit 1104.

Descriptive information acquisition unit 1101 may be configured to acquire descriptive information of an object to be captured by a photo-taking device, as discussed above in connection with FIGS. 6-7.

Request sending unit 1102 may be configured to send a request for photo-taking recommendation to a server, as discussed above in connection with FIGS. 6-7.

Recommendation providing unit 1103 may be configured to provide photo-taking recommendation information based on the target photo-taking template returned by the server, as discussed above in connection with FIGS. 6-7.

Photo-taking unit 1104 may be configured to shoot a photo of the object based on the photo-taking recommendation information, as discussed above in connection with FIGS. 6-7.

The specification has described apparatuses and methods for creating a photo-taking template database and for providing photo-taking recommendation. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method, implemented by a processor device, for creating a photo-taking template database, comprising:
acquiring an image based on a preset initial condition;
determining, by the processor device, whether the image meets at least one qualification factor;
storing the image as a photo-taking template in the photo-taking template database when it is determined that the image meets at least one qualification factor;
determining, by the processor device, descriptive information based on information obtained from the image;
storing the descriptive information in the photo-taking template database; and
associating the photo-taking template with the descriptive information.

2. The method of claim 1, wherein acquiring the image based on the preset initial condition includes:
acquiring the image if the image includes a figure of a person or a body part of a person.

3. The method of claim 2, wherein the at least one qualification factor includes an assessment of at least one of:
image background;
image outline of the figure;
a position of the figure in the image;
a scale of the figure with respect to the image; or
whether the image includes a mark indicating that the image qualifies as a photo-taking template.

4. The method of claim 1, wherein the image includes a figure of a merchandise object, and wherein determining the descriptive information includes:
acquiring information associated with the figure of the merchandise object; and
determining the descriptive information based on the acquired information associated with the figure of the merchandise object.

5. The method of claim 4, wherein the descriptive information includes at least one of:
identification information of the merchandise object;
category information of the merchandise object; or
identification information of a seller of the merchandise object.

6. The method of claim 2, wherein determining the descriptive information includes:
acquiring information associated with the figure of the person or the body part; and
determining the descriptive information based on the acquired information associated with the figure of the person or the body part.

7. The method of claim 1, wherein the photo-taking template includes a figure of a person and the method comprises:
identifying a profile curve of the figure of the person in the photo-taking template;
determining position information of the profile curve in the photo-taking template; and
storing the position information of the profile curve in the photo-taking template database.

8. A method, implemented by a processor device, for providing photo-taking recommendation information, the method comprising:
acquiring descriptive information of an object to be captured by a photo-taking device;
sending a request for photo-taking recommendation to a server storing a plurality of photo-taking templates, the request including the descriptive information;
receiving a photo-taking template from the server, wherein the photo-taking template is associated with descriptive information of one or more figures included in the photo-taking template and wherein the descriptive information associated with the photo-taking template at least partially matches the descriptive information of the object to be captured; and
providing, by the processor device, photo-taking recommendation information based on the received photo-taking template.

9. The method of claim 8, comprising:
receiving position information of a profile curve of at least one figure in the photo-taking template;
activating the photo-taking device to capture a live image;
displaying the live image on an interface; and
displaying a recommendation profile curve overlaid with the live image based on the received position information.

10. The method of claim 8, wherein the object is a merchandise object and the method comprises:
receiving, from a buyer of the merchandise object, a request for taking a photo of the merchandise object; and
acquiring the descriptive information of the merchandise object.

11. The method of claim 10, comprising:
providing, on an interface associated with a purchase order of the merchandise object, a first portal for photo submission by the buyer; and
receiving, through the first portal, the request for taking the photo of the merchandise object from the buyer.

12. The method of claim 11, comprising:
acquiring the descriptive information of the merchandise object from the purchase order.

13. The method of claim 11, comprising:
sending a photo of the merchandise object and identification information of the purchase order to the server.

14. The method of claim 8, wherein the object is a merchandise object and the method comprises:
receiving, from a seller of the merchandise object, a request for taking a photo of the merchandise object; and
acquiring the descriptive information of the merchandise object.

15. The method of claim 14, wherein the merchandise object is a product to be released and the method comprises:
providing, on an information release interface associated with the merchandise object, a second portal for photo submission by the seller; and
receiving, through the second portal, the request for taking the photo of the merchandise object from the seller.

16. The method of claim 15, comprising:
acquiring the descriptive information of the merchandise object based on data in the information release interface.

17. The method of claim 14, wherein the merchandise object is a released product and the method comprises:
providing, on an information editing interface associated with the merchandise object, a third portal for photo submission by the seller; and
receiving, through the third portal, the request for taking the photo of the merchandise object from the seller.

18. The method of claim 17, comprising:
acquiring the descriptive information of the merchandise object from the server.

19. The method of claim 14, comprising:
sending a photo of the merchandise object and identification information of the merchandise object to the server.

20. An apparatus for providing photo-taking recommendation information, comprising:
a memory device storing a photo-taking template database, wherein the photo-taking template stores a plurality of photo-taking templates, wherein each photo-taking template is associated with descriptive information of one or more figures included in the photo-taking template; and
a processor device communicatively coupled to the memory device, wherein the processor device is configured to:
receive a request for photo-taking recommendation from a client device, the request including descriptive information of an object to be captured by a photo-taking device;
perform matching operation between the descriptive information of the object to be captured and the descriptive information associated with each photo-taking template in the photo-taking template database;
determine whether a target photo-taking template is found in the photo-taking template database, wherein the descriptive information associated with the target photo-taking template at least partially matches the descriptive information of the object to be captured; and
if a target photo-taking template is found, send the target photo-taking template to the client device.
